(19) United States
(12) Patent Application Publication
(10) Pub. No.: US 2024/0097501 A1
(43) Pub. Date: Mar. 21, 2024

(54) FOREIGN OBJECT DETECTION DURING WIRELESS POWER TRANSMISSION

(71) Applicant: Apple Inc., Cupertino, CA (US)

(72) Inventors: Nan Liu, Sunnyvale, CA (US); Aijun Qin, Auckland (NZ); Ge Wang, San Jose, CA (US); Jinqian Yu, Campbell, CA (US); Kunal Bhargava, Auckland (NZ); Patrin K. Illenberger, Auckland (NZ); Rex P. Huang, Auckland (NZ)

(21) Appl. No.: 18/062,143

(22) Filed: Dec. 6, 2022

Related U.S. Application Data
(60) Provisional application No. 63/376,216, filed on Sep. 19, 2022.

(51) Int. Cl. H02J 50/60; H02J 50/10; H02J 50/80

(52) U.S. Cl. CPC H02J 50/60; H02J 50/10; H02J 50/80; H02J 2207/20; H04B 5/0037

(57) ABSTRACT

A wireless power transmitter can include a wireless power transfer coil designed to magnetically couple with a corresponding coil in a wireless power receiver to facilitate wireless power transfer from the wireless power transmitter to the wireless power receiver, a power converter configured to drive the wireless power transfer coil, and control and communications circuitry coupled to the wireless power transfer coil and the power converter. The control and communications circuitry can be configured to operate the power converter to drive the wireless power transfer coil so as to transfer power to the wireless power receiver in accordance with a negotiated power transfer. Simultaneously during power transfer, the control and communications circuitry can send a polling signal to detect a foreign object including a wireless transponder and reduce or stop wireless power transfer upon receiving a response to the polling signal from a foreign object including a wireless transponder.

### BACKGROUND

Wireless power transfer (“WPT”), such as inductive power transfer (“IPT”), may be used to provide power for charging various battery-powered electronic devices. WPT has seen increased use in the consumer electronics space around devices such as mobile phones (i.e., smart phones) and their accessories (e.g., wireless earphones, smart watches, etc.) as well as tablets and other types of portable computers and their accessories (e.g., styluses, etc.). Such WPT systems may employ foreign object detection (“FOD”) systems that attempt to identify conductive objects separate from the wireless power transmitter and wireless power receiver, so that the transferred wireless power can be regulated to prevent unnecessarily delivering power to such objects.

### SUMMARY

Operation of foreign objects that include wireless transponder type devices, such as NFC, RFID, RF, so forth, can potentially be affected by the wireless power transfer. Techniques for detecting the presence of such devices in proximity to a wireless power transfer system and accordingly controlling the level of power wirelessly transferred are advantageous.

A wireless power transmitter can include a wireless power transfer coil designed to magnetically couple with a corresponding coil in a wireless power receiver to facilitate wireless power transfer from the wireless power transmitter to the wireless power receiver, a power converter configured to drive the wireless power transfer coil, and control and communications circuitry coupled to the wireless power transfer coil and the power converter. The control and communications circuitry can be configured to operate the power converter to drive the wireless power transfer coil so as to transfer power to the wireless power receiver in accordance with a negotiated power transfer. Simultaneously during power transfer, the control and communications circuitry can send a polling signal to detect a foreign object including a wireless transponder and reduce or stop wireless power transfer upon receiving a response to the polling signal from a foreign object including a wireless transponder.

The control and communication circuitry can transfer power and simultaneously send the polling signal at the same frequency. The frequency can be 13.56 MHz. The control and communications circuitry can transfer power and simultaneously send the polling signal continuously, periodically, or intermittently during power transfer.

The control and communications circuitry can transfer power and simultaneously send the polling signal by: detecting a change in one or more parameters of the wirelessly transferred power, comparing the detected change in the one or more parameters of the wirelessly transferred power to a first threshold to detect a foreign object, and comparing the detected change in the one or more parameters of the wirelessly transferred power to a second threshold to detect a foreign object including a wireless transponder. If a foreign object is detected by comparison of the detect change to the first threshold, the control and communications circuitry can stop wireless power transfer. If a foreign object including a wireless transponder is detected by the comparison of the detected change to the second threshold, the control and communications circuitry can reduce wireless power transfer. The second threshold can be less selective than the first threshold.

The one or more parameters of the wirelessly transferred power can include one or more parameters selected from the group consisting of: voltage, current, frequency, phase angle, or one or more values derived therefrom. The one or more values derived from voltage, current, frequency, or phase angle can include at least one of power, efficiency, or wireless power receiver impedance.

The wireless transponder can be an NFC or RFID tag. The polling signal can include a SENS_REQ command in accordance with an NFC Digital Protocol standard. The response to the polling signal can include a SENS_RES response in accordance with the NFC Digital Protocol Standard.

A method of controlling a wireless power transmitter can be performed by control and communication circuitry of the wireless power transmitter and can include transferring power to a wireless power receiver and simultaneously sending a polling signal to detect a foreign object including a wireless transponder, and reducing or stopping wireless power transfer upon receiving a response to the polling signal from a foreign object including a wireless transponder. Transferring power and simultaneously sending the polling signal can occur at the same frequency, which can be 13.56 MHz. Simultaneously sending the polling signal can occur continuously, periodically, or intermittently during power transfer. The polling signal can include a SENS_REQ command in accordance with an NFC Digital Protocol standard. The response to the polling signal can include a SENS_RES response in accordance with the NFC Digital Protocol Standard standard.

A method of controlling a wireless power transmitter can be performed by control and communication circuitry of the wireless power transmitter and can include transferring power to a wireless power receiver and simultaneously sending a polling signal to detect a foreign object including a wireless transponder, detecting a change in one or more parameters of the wirelessly transferred power. The method can further include comparing the detected change in the one or more parameters of the wirelessly transferred power to a first threshold to detect a foreign object. If a foreign object is detected by comparison of the detect change to the first threshold, the method can further include reducing or stopping wireless power transfer. The method can also include comparing the detected change in the one or more parameters of the wirelessly transferred power to a second threshold to detect a foreign object including a wireless transponder. If a foreign object including a wireless transponder is detected by the comparison of the detected change to the second threshold, the method can further include reducing or stopping wireless power transfer.

Transferring power and simultaneously sending the polling signal occur at the same frequency, which can be 13.56 MHz. The second threshold can be less selective than the first threshold. The one or more parameters of the wirelessly transferred power can include one or more parameters selected from the group consisting of: voltage, current, frequency, phase angle, or one or more values derived therefrom. The one or more values derived from voltage, current, frequency, or phase angle can include at least one of power, efficiency, or wireless power receiver impedance.

### BRIEF DESCRIPTION OF THE DRAWINGS

FIG. 1 illustrates a block diagram of a wireless power transfer system.

FIG. 2 illustrates foreign objects in a wireless power transfer system.

FIG. 3 illustrates a wireless power transfer process.

FIG. 4 illustrates a wireless power transfer process with enhanced NFC foreign object detection.

FIG. 5 illustrates a more detailed flowchart of a wireless power transfer process with enhanced NFC foreign object detection.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a drawing, refers to the same element throughout the several drawings, though it may not be repeated in every drawing. The drawings are not to scale unless otherwise indicated, and the proportions of certain parts may be exaggerated to better illustrate details and features of the present disclosure.

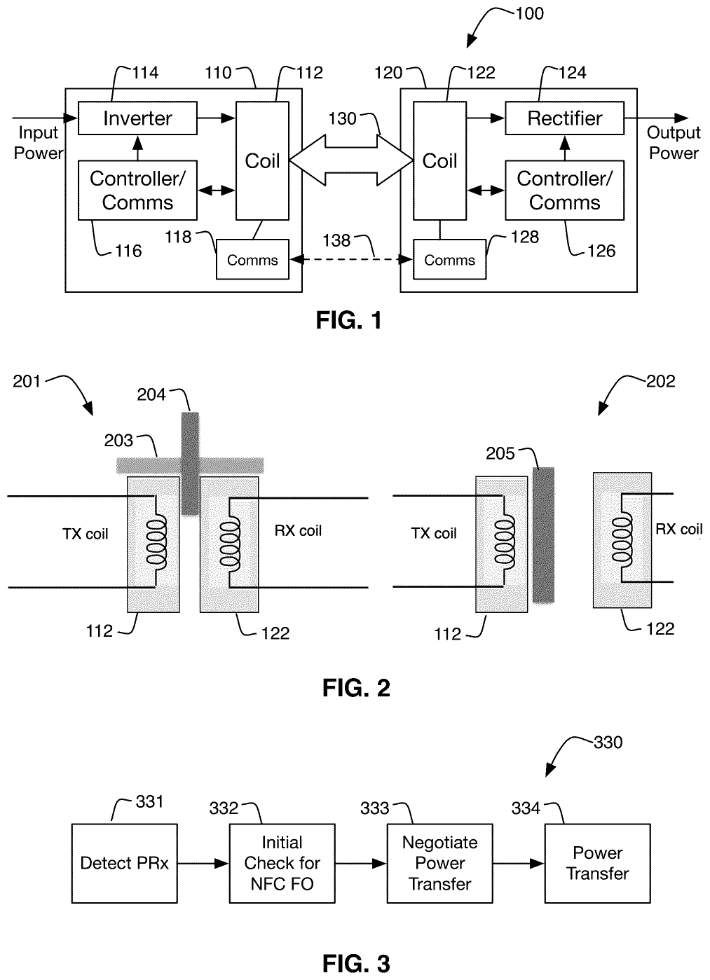

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications (“comms”) module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PRx device 120 may optionally include other systems and components, such as a communications module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

Users of devices wireless power transfer devices may also have a variety of devices that incorporate near field communications (NFC) tags, radio frequency identification (RFID) tags, or similar wireless transponder type devices. Examples of such devices with NFC or RFID tags may include payment cards, keyless entry pass cards, transit pass cards, passports, etc. Other devices that may incorporate wireless transponder type devices include automotive keyless entry fobs, etc. These and other devices that include antennas or coils that can effectively couple to the wireless power transfer system can be susceptible to induced currents from wireless power transfer as discussed above. This unintended inducing of electrical current can be higher if the dimensions, materials, operating frequency, etc. of the NFC tag, RFID tag, or similar wireless transponder type device lends itself to better coupling with the wireless power transfer system. For purposes of this description, such devices may be collectively referred to as NFC tags; however, the principles discussed herein are applicable to all such transponder type devices, including NFC, RFID, radio frequency (RF) devices, etc.

FIG. 2 illustrates foreign objects in a wireless power transfer system. More specifically, view 201 of FIG. 2 illustrates a wireless power transmit coil 112 and a wireless power receive coil 122 in proximity for a wireless power transfer operation. View 201 further illustrates two foreign objects 203 and 204. Foreign object 203 is positioned adjacent to the wireless power transfer coils. Foreign object 204 is positioned adjacent to and between the wireless power transfer coils. If either foreign object 203 or foreign object 204 is or contains an NFC or RFID tag or similar wireless transponder type device, there is a chance that such devices positioned as shown may be susceptible to currents induced in such devices by the magnetic field associated with the wireless charging operation. View 202 illustrates a view where a foreign object 205 is positioned between wireless power transmit coil 112 and wireless power receive coil 122. If foreign object 205 is or contains an NFC or RFID tag or other similar wireless transponder type device, it may react to induced current as it is located between PTx and PRx.

Embodiments of wireless power transfer systems may employ various schemes to detect the presence of an NFC tag, RFID tag, or wireless transponder in proximity to the wireless power transfer system and reduce the power level or stop wireless power transfer when such devices are in proximity. FIG. 3 illustrates an example of a wireless power transfer process 330 that may be performed by a wireless power transmitter (PTx) and includes detection for NFC devices. (The same principles apply to RFID, RF, or other wireless transponder type devices). Process 330 can be performed by PTx 110, including by control and communication circuitry 116 of PTx 110. Beginning at block 331, the PTx can detect the presence of a PRx, which can be used to initiate the wireless power transfer process. However, before commencing power transfer, or before commencing power transfer at a higher power threshold level, the PTx can check for the presence of an NFC foreign object (block 332).

The process of checking for an NFC foreign object can include the PTx operating the wireless power transfer system to send out an NFC interrogation signal that would elicit a response from an NFC device. This can include the use of in-band communications using inverter 114 and wireless power transmit coil 112 and/or can include the use of an out of band communications module 118. Various types of NFC devices may be configured to respond to one or more specified interrogation signals in a specified way. By configuring a wireless PTx to send such interrogation signal(s) and listen for the specified response, the PTx can essentially act as an NFC tag reader and thereby detect the presence of an NFC tag. Similar principles may be applied to RFID, RF, or other transponder devices. In other words, the PTx may be configured to send an interrogation signal as part of the wireless power transfer startup process. The PTx may be further configured to detect a response corresponding to the interrogation signal and to account for this response in further establishment and conduct of wireless power transfer. The configuration of the PTx can include programming one or more microprocessors or microcontrollers making up the controller and communications circuitry of the PTx. Alternatively, such configuration may be partially or completely based on the configuration of other digital, analog, or hybrid control circuitry in the PTx, including application specific integrated circuits (ASICs), field programmable gate arrays (FPGAs), etc.

Subsequent to the check for an NFC (or other wireless transponder) foreign object, the PTx can negotiate power transfer with the PRx (block 333). In some applications, this negotiation (and subsequent power transfer) can be stopped responsive to the presence of the NFC foreign object. In other cases, the negotiation can account for the presence of the NFC foreign object and negotiate power transfer at a lower level to reduce currents induced in the NFC (or other wireless transponder) foreign object. Following the negotiation, power transfer can commence (block 334). One power transmission opportunity of process 330 is that if an NFC (or other wireless transponder) foreign object is brought into proximity with the wireless power transfer system after power transfer has commenced (block 334), the system may not be able to detect this and reduce or stop wireless power transfer.

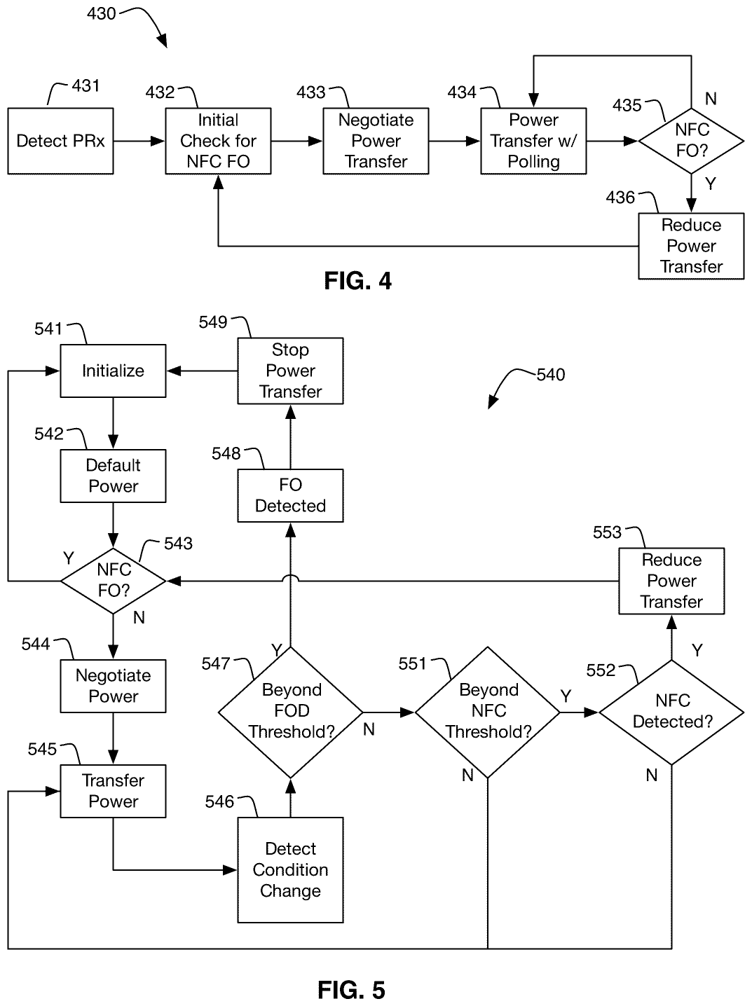

FIG. 4 illustrates a wireless power transfer process 430 with enhanced NFC foreign object detection. (The same principles apply to RFID, RF, or other wireless transponder type devices). Process 430 can be performed by PTx 110, including by control and communication circuitry 116 of PTx 110. Beginning at block 431, the PTx can detect the presence of a PRx, which can be used to initiate the wireless power transfer process. However, before commencing power transfer, or at least before commencing power transfer at a power level that may induce significant currents to transponder type devices, the PTx can check for the presence of an NFC foreign object (block 432).

The process of checking for an NFC foreign object can include the PTx operating the wireless power transfer system to send out an NFC interrogation signal that would elicit a response from an NFC device. This can include the use of in-band communications using inverter 114 and wireless power transmit coil 112 and/or can include the use of an out of band communications module 118. Various types of NFC devices may be configured to respond to one or more specified interrogation signals in a specified way. By configuring a wireless PTx to send such interrogation signal(s) and listen for the specified response, the PTx can essentially act as an NFC tag reader and thereby detect the presence of an NFC tag. Similar principles may be applied to RFID, RF, or other transponder devices. In other words, the PTx may be configured to send an interrogation signal as part of the wireless power transfer startup process. The PTx may be further configured to detect a response corresponding to the interrogation signal and to account for this response in further establishment and conduct of wireless power transfer. The configuration of the PTx can include programming one or more microprocessors or microcontrollers making up the controller and communications circuitry of the PTx. Alternatively, such configuration may be partially or completely based on the configuration of other digital, analog, or hybrid control circuitry in the PTx, including application specific integrated circuits (ASICs), field programmable gate arrays (FPGAs), etc.

Subsequent to the check for an NFC (or other wireless transponder) foreign object, the PTx can negotiate power transfer with the PRx (block 433). In some applications, this negotiation (and subsequent power transfer) can be stopped based on the presence of the NFC foreign object. In other cases, the negotiation can account for the presence of the NFC foreign object and negotiate power transfer at a lower level selected to be low to reduce electrical currents induced in the NFC (or other wireless transponder) foreign object. Following the negotiation, power transfer can commence (block 434), with the difference that the wireless power transfer continues with simultaneous polling for an NFC (or other wireless transponder) foreign object. Then, the PTx can monitor for a response from an NFC (or other wireless transponder) foreign object in response to the polling that takes place simultaneously with the wireless power transfer. If an NFC (or other wireless transponder) foreign object is detected (block 435), then wireless power transfer can be reduced (block 436), and the system (e.g., PTx) can re-check for an NFC foreign object (block 432) and renegotiate power transfer accordingly (block 433).

In some embodiments, the polling for an NFC object can include the PTx sending a “SENS_REQ” command as specified by the NFC Digital Protocol published by the NFC Forum. In response to this polling command, an NFC device could respond with a “SENS_RES” response, also as specified by the NFC Digital Protocol. Upon receiving the SENS_RES response, the PTx can determine that an NFC object is present in the vicinity of the wireless power transfer system and can reduce, stop, or otherwise limit power transfer as appropriate. The foregoing example is one technique for detecting standard NFC foreign objects; however, the polling communication could be sent according to one or more suitable protocols, including any applicable industry standard protocol or a proprietary protocol, with the protocols being selected to correspond to the type of wireless transponder based foreign object of interest.

Process 430 as described above can allow for rapid detection of an NFC (or other wireless transponder) foreign object, which can then trigger a reduction in power transfer, up to or including a cessation of wireless power transfer to prevent inducing current into the NFC (or other wireless transponder) foreign object. In at least some cases, the polling may occur at the same or substantially the same frequency as the wireless power transfer. For example, in some applications it may be advantageous to perform wireless charging at a frequency of 13.56 MHz, which corresponds to a commonly used NFC frequency. However, this use of the same frequency can increase the amount of electrical currents induced into an NFC tag, as the wireless power transfer field may more effectively couple into an NFC tag designed to operate at the same frequency. Similarly, in some applications it may be desirable to conduct wireless power transfer at a frequency of 128 kHz, which corresponds to a frequency sometimes used for automotive keyless entry fobs. However, this use of the same frequency can induce electrical currents in a keyless entry fob, as the wireless power transfer field may more effectively couple into a key fob designed to operate at the same frequency. Thus, the polling technique described above may be advantageously employed in applications where the wireless power transfer frequency is the same as or close to a frequency used for operation of other devices that may end up in proximity to the wireless power transfer system, although the use of such polling techniques need not be limited to just same frequency operation.

FIG. 5 illustrates a more detailed flowchart of a wireless power transfer process 540 with enhanced NFC foreign object detection. The illustrated process 540 may be performed by PTx 110, including by control and communication circuitry 116, and is but one example consistent with the broader principle discussed above with respect to FIG. 4. Process 540 could be modified to include more, fewer, or different steps, including a different order of steps, without departing from the teachings of the present disclosure. Process 540 can begin with initialization (block 541), which can include detecting the presence of a wireless power receiver (PRx). Then, wireless power transfer may begin at a default power level (block 542). This default power level may be a relatively lower power level selected at least in part to avoid inducing currents into NFC (or other transponder) devices. This low/default level of wireless power transfer can allow for in-band communication between PTx and PRx using modulation of various characteristics of the power, as was described above with respect to FIG. 1. Alternatively, wireless power transfer may be foregone completely until subsequently in the process.

Then, in block 543, the PTx can employ an NFC (or other wireless transponder) detection. This can include any of a variety of polling techniques. It is noted that block 543 can correspond generally to block 432 discussed above with respect to FIG. 4 and block 332 discussed above with respect to FIG. 3. If an NFC (or other wireless transponder) foreign object is detected, then process 540 can return to the initialization block 541. Otherwise, the PTx can negotiate power transfer with the PRx (block 544). In some cases, even if an NFC (or other wireless transponder) foreign object is detected in block 543, the power negotiation of block 544 can continue, with the negotiated power level being affected by the known presence of the NFC (or other wireless transponder) foreign object. For example, power transfer could be negotiated to a sufficiently low power level that currents induced into the NFC (or other wireless) transponder are negligible, e.g., do not interfere with operation of the NFC device.

Following the power transfer negotiation (block 544) wireless power transfer may commence (block 545). In some cases, this can include simultaneous polling for an NFC (or other wireless power transfer). During wireless power transformer, various parameters associated with the wireless power transfer (voltage, current, frequency, phase angle, etc.) or quantities derived therefrom (e.g., transmitted power, received power, efficiency, receiver impedance, etc.) may be monitored to detect (block 546) a change in conditions. The change in conditions may be detected either by the value or magnitude of the monitored parameter value (e.g., efficiency falling below 35% can indicate the presence of a foreign object) or by the delta associated with the change (e.g., a >10% increase in power not requested by the PRx can indicate the presence of a foreign object). As used in this description, a change in the monitored parameters or quantities derived therefrom can be any of these values, magnitudes, deltas, etc. The change in these various parameters or the quantities derived therefrom can indicate the presence of a foreign object, including a foreign object that includes an NFC tag, an RFID tag, or a wireless transponder of some sort.

Thus, the value of a monitored parameter(s) or one or more quantity(ies) derived therefrom can be compared to a first foreign object detection threshold (block 547). If the change in the monitored parameter(s) or quantity(ies) derived therefrom and/or the value of the monitored parameter(s) or quantity(ies) derived therefrom crosses this first object detection threshold, then the presence of a foreign object may be inferred (block 548), and power transfer can be stopped (block 549). This can be followed by eventual reinitialization of process 540 (block 541). Depending on the particular parameter or value monitored, the threshold may be crossed by a value that exceeds the threshold or falls below the threshold. The change may also correspond to the magnitude of the change or a change that causes the value to cross the threshold.

NFC detection (block 552) can be based on polling that is performed continuously, periodically, or intermittently but simultaneously with the negotiated wireless power transfer commenced in block 545. In this sense, continuous means that the polling continues throughout the power transfer. Periodically means that the polling need not be continuous but occurs at regular or irregular intervals during wireless power transfer. Such intervals may be time based, such as upon expiration of a timer, which may vary depending on operational conditions. Intermittently means that the polling does occurs at various times during wireless power transfer, but that these occurrences need not be temporally determined. In other words, intermittent polling may be triggered by some event other than just expiration of a fixed or variable timer. For example, NFC detection (block 552) can be triggered in response to the second NFC threshold as described above.

In any case, detection of an NFC foreign object in block 552 can trigger an immediate reduction in wireless power transfer level (block 553) to prevent inducing currents in the NFC foreign object. The process can further include additional NFC detection (block 543), with the power level being renegotiated and/or the process being reinitialized accordingly. Otherwise, if the NFC detection of block 552 does not indicate the presence of an NFC object or if the monitored value or parameter does not exceed the second threshold in block 551, then power transfer can continue as negotiated (block 545). This continued power transfer can include continued monitoring to detect a change in impedance or power transfer parameters (block 546) along with comparison of these values or the changes in these values to appropriate thresholds to detect a foreign object and/or an NFC foreign object as described above.

In the example of FIG. 5, an NFC foreign object is used as an example of an NFC, RFID, or other wireless transponder type foreign object. However, as noted above, the technique need not be limited to NFC. Rather it could be applied to RFID, RF, or other types of wireless transponder objects that could be affected by the wireless power transfer. This can include but need not be limited to those designed to operate at frequencies the same as or substantially similar to the wireless power transfer system. This can also include but need not be limited to those that have a size, material, or other physical configuration that makes them susceptible to coupling with the wireless power transfer system that could result in interference from the wireless power transfer process.

Described above are various features and embodiments relating to wireless power transfer transmitters that include foreign object detection specifically configured or selected to reduce inducing electrical currents in NFC, RFID, RF, or other wireless transponder type devices. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information amongst the PTx and PRx in the system. Such information may be used in a variety of ways, including those described herein, to enhance the operation of the wireless power transfer system. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

Risk can be minimized by limiting the collection of data and deleting data once it is no longer needed. In addition, and when applicable, data de-identification can be used to protect a user's privacy. For example, a device identifier may be partially masked to convey the power characteristics of the device without uniquely identifying the device. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. Robust encryption may also be utilized to reduce the likelihood that communication between inductively coupled devices are spoofed.

1. A wireless power transmitter comprising:
a wireless power transfer coil designed to magnetically couple with a corresponding coil in a wireless power receiver to facilitate wireless power transfer from the wireless power transmitter to the wireless power receiver;
a power converter configured to drive the wireless power transfer coil; and
control and communications circuitry coupled to the wireless power transfer coil and the power converter configured to operate the power converter to drive the wireless power and:
transfer power to the wireless power receiver in accordance with a negotiated power transfer and simultaneously sends a polling signal to detect a foreign object including a wireless transponder; and
reduce or stop wireless power transfer upon receiving a response to the polling signal from a foreign object including a wireless transponder.

2. The wireless power transmitter of claim 1 wherein the control and communication circuitry transfers power and simultaneously sends the polling signal at the same frequency.

3. The wireless power transmitter of claim 2 wherein the frequency is 13.56 MHz.

4. The wireless power transmitter of claim 1 wherein the control and communications circuitry transfers power and simultaneously sends the polling signal continuously during power transfer.

5. The wireless power transmitter of claim 1 wherein the control and communications circuitry transfers power and simultaneously sends the polling signal periodically during power transfer.

6. The wireless power transmitter of claim 1 wherein the control and communications circuitry transfers power and simultaneously sends the polling signal intermittently during power transfer.

7. The wireless power transmitter of claim 1 wherein the control and communications circuitry transfers power and simultaneously sends the polling signal by:
detecting a change in one or more parameters of the wirelessly transferred power;
comparing the detected change in the one or more parameters of the wirelessly transferred power to a first threshold to detect a foreign object; and
comparing the detected change in the one or more parameters of the wirelessly transferred power to a second threshold to detect a foreign object including a wireless transponder.

8. The wireless power transmitter of claim 7 wherein:
if a foreign object is detected by comparison of the detect change to the first threshold, the control and communications circuitry stops wireless power transfer; and
if a foreign object including a wireless transponder is detected by the comparison of the detected change to the second threshold, the control and communications circuitry reduces wireless power transfer.

9. The wireless power transmitter of claim 7 wherein the second threshold is less selective than the first threshold.

10. The wireless power transmitter of claim 7 wherein the one or more parameters of the wirelessly transferred power include one or more parameters selected from the group consisting of: voltage, current, frequency, phase angle, or one or more values derived therefrom.

11. The wireless power transmitter of claim 10 wherein the one or more values derived from voltage, current, frequency, or phase angle include at least one of power, efficiency, or wireless power receiver impedance.

12. The wireless power transmitter of claim 1 wherein the wireless transponder is an NFC or RFID tag.

13. The wireless power transmitter of claim 12 wherein the polling signal includes a SENS_REQ command and the response to the polling signal includes a SENS_RES response.

14. A method of controlling a wireless power transmitter performed by control and communication circuitry of the wireless power transmitter, the method comprising:
transferring power to a wireless power receiver and simultaneously sending a polling signal to detect a foreign object including a wireless transponder; and
reducing or stopping wireless power transfer upon receiving a response to the polling signal from a foreign object including a wireless transponder.

15. The method of claim 14 wherein transferring power and simultaneously sending the polling signal occur at the same frequency.

16. The method of claim 15 wherein the frequency is 13.56 MHz.

17. The method of claim 14 wherein simultaneously sending the polling signal occurs continuously during power transfer.

18. The method of claim 14 wherein simultaneously sending the polling signal occurs periodically during power transfer.

19. The method of claim 14 wherein simultaneously sending the polling signal occurs intermittently during power transfer.

20. The method of claim 14 wherein the polling signal includes a SENS_REQ command and the response to the polling signal includes a SENS_RES response.

21. A method of controlling a wireless power transmitter performed by control and communication circuitry of the wireless power transmitter, the method comprising:
transferring power to a wireless power receiver and simultaneously sending a polling signal to detect a foreign object including a wireless transponder;
detecting a change in one or more parameters of the wirelessly transferred power; and
comparing the detected change in the one or more parameters of the wirelessly transferred power to a first threshold to detect a foreign object, and, if a foreign object is detected by comparison of the detect change to the first threshold, reducing or stopping wireless power transfer; or
comparing the detected change in the one or more parameters of the wirelessly transferred power to a second threshold to detect a foreign object including a wireless transponder, and if a foreign object including a wireless transponder is detected by the comparison of the detected change to the second threshold, reducing or stopping wireless power transfer.

22. The method of claim 21 wherein transferring power and simultaneously sending the polling signal occur at the same frequency.

23. The method of claim 22 wherein the frequency is 13.56 MHz.

24. The method of claim 21 wherein the second threshold is less selective than the first threshold.

25. The method of claim 21 wherein the one or more parameters of the wirelessly transferred power include one or more parameters selected from the group consisting of: voltage, current, frequency, phase angle, or one or more values derived therefrom.

26. The method of claim 25 wherein the one or more values derived from voltage, current, frequency, or phase angle include at least one of power, efficiency, or wireless power receiver impedance.
